(19) United States
(12) Patent Application Publication
(10) Pub. No.: US 2005/0026003 A1
(43) Pub. Date: Feb. 3, 2005

(54) Calcium phosphate colloids, dots, islands, thin films or granules and its preparation

(76) Inventors: Hyun-Man Kim, Seoul (KR); Jea-Seung Ko, Seoul (KR); Zang Hee Lee, Seoul (KR)

Correspondence Address: JHK Law, P.O. Box 1078, La Canada, CA, 19012-1078, US

(21) Appl. No.: 10/927,603

(22) Filed: Aug. 25, 2004

(30) Foreign Application Priority Data
Feb. 26, 2002 (KR) 10-2002-0010226
Feb. 27, 2002 (KR) 10-2002-0010359
Feb. 26, 2003 (WO) PCT/KR03/00389

(51) Int. Cl. C01B 25/32; B32B 9/04

(52) U.S. Cl. 428/704; 423/305

(57) ABSTRACT

The present invention relates to the preparing methods of calcium phosphate ion solutions stabilized at a low temperature and calcium phosphate colloids which are made in the calcium phosphate ion solutions. The calcium phosphate colloids provide calcium phosphate dots, islands, or thin films by having them attached and grown on the solid surfaces, or calcium phosphate granules by having them grown in the solution.

### TECHNICAL FIELD

The present invention relates to the novel methods preparing calcium phosphate ion solutions, and calcium phosphate colloid ion solutions prepared by using the calcium phosphate ion solutions. Also, the present invention relates to calcium phosphate dots, islands, or thin films obtained by having them attached and grown on the solid surface, and calcium phosphate granules by having them grown in the solution.

### BACKGROUND OF THE INVENTION

Calcium phosphate is a substance with biocompatibility, which is found in biologically-calcified tissues [H.-M. Kim et al., J. Bone Miner. Res. 1995, 10., 1589-1601; U.S. Pat. No. 5,565,502; and U.S. Pat. No 5,691,397], and which is well known as a biomaterial, especially as a bone substitute.

Calcium phosphate has high absorption capacity against organic matters and inorganic matters. Thus, calcium phosphate is used as a heavy metal remover and deodorizer in the form of rods, needles, flakes, foils, bars, or granules.

Calcium phosphate can be used as various forms. For instance, thin film of calcium phosphate crystals is effective in enlarging the surface area and can efficiently remove heavy metals from aqueous solutions by using its high absorption capacity against heavy metals, and thus can be used in purifying water. Thin film of calcium phosphate crystals is also commonly used to modify biomaterial surface since it enhances biocompatibility while maintaining the properties of the biomaterial.

However, such crystal thin film is formed all over the surface of the solid substrate and thus, has disadvantages. For examples, when applied to biodegradable polymer, the biodegradability can be reduced since it blocks direct contact between polymer and tissue fluid. Also, the crystal thin film can be easily separated from the solid substrate when the substrate such as polymer or titanium substrate is deformed. And further the tissue formed on the calcium phosphate can also be separated from the substrate together with calcium phosphate thin film as a result of the deformation of the substrates.

Therefore, a new form of calcium phosphate is required so that biological reaction is efficiently performed on solid substrate and the calcium phosphate is not easily separated due to external force or the deformation of the solid substrate.

As another useful form of calcium phosphate, calcium phosphate granules can be used for carriers for drug or cell delivery and filters for mass separation.

Calcium phosphate can be prepared with the calcium phosphate ion solution, which can be prepared with a group of all compounds comprising Ca²⁺ ion and PO₄³⁻ ion. Compounds comprising Ca²⁺ ions can be exemplified by Ca(OH)₂, CaCO₃, Ca(NO₃)_{2.4}H₂O, Ca(CH₃COOH)₂.H₂O, CaCl₂, or CaSO₄.2H₂O, and compounds comprising PO³⁻ ions can be exemplified by H₃PO₄, (NH₄)₂HPO₄, or H₄P₂O₇. Calcium phosphate compounds whose Ca/P mole ratio is. 0.8˜2.0 can be also used to prepare the calcium phosphate ion solution to obtain the new forms of the calcium phosphate. Those calcium phosphate compounds can be exemplified by Monocalcium Phosphate Monohydrate, Dicalcium phosphate Dihydrate, Dicalcium Phosphate Anhydrate, Octacalcium Phosphate, Amorphous Calcium Phosphate, Hydroxyapatite and Tricalcium Phosphate.

Various forms of calcium phosphate compounds can be prepared by mixing Ca²⁺ ions and PO₄³⁻ ions at various conditions in an aqueous solution, and it is known that the type and form of the compound are largely affected by ion concentration, Ca/P ratio, and pH condition [Ayako Oyane, Kazuo Onuma, Tadashi Kokubo, and Atsuo Ito J. Phys. Chem. B 1999, 103, 8230-8235, Elliott J. C. In Structure and Chemistry of the Apatites and Other Calcium Orthophosphates, Studies in Inorganic Chemistry 18, Amsterdam: Elsevier, pp 111-190 (1994)].

### SUMMARY OF THE INVENTION

It is an object of the present invention to provide a method for preparing a calcium phosphate ion solution comprising first embodiment and second embodiment.

It is another object of the present invention to provide a calcium phosphate colloid ion solution prepared by maintaining the calcium phosphate ion solution at a low temperature.

Also, it is another object of the present invention to provide dots, islands, or thin films of calcium phosphate prepared on the solid surface using said solution as well as granules prepared in the calcium phosphate colloid ion solution.

### BRIEF DESCRIPTION OF THE DRAWINGS

FIG. 1 is the transmission electron microscopic picture (×100,000) of the calcium phosphate colloid attached to a substrate as dots, which is observed on the formvar film put over the calcium phosphate ion solution free of colloid at low temperature, after adding the calcium phosphate colloid ion solution to the ion solution,

FIG. 2 is the transmission electron microscopic picture (×100,000) of the calcium phosphate amorphous phase dots of the present invention,

FIG. 3 is the transmission electron microscopic picture (×100,000) of amorphous phase dots of calcium phosphate of the present intention that are converted into crystals,

FIG. 4 is the transmission electron microscopic picture (×100,000) of the crystal islands converted and grown from calcium phosphate amorphous phase dots,

FIG. 5 is the transmission electron microscopic picture (×100,000) of the calcium phosphate thin film of the present invention grown from calcium phosphate crystal islands,

FIG. 6 is the scanning electron microscopic picture (×2,000) of the calcium phosphate granules of the present invention,

FIG. 7 is the phase contrast microscopic picture (×200) of the osteoblast cell line cultured on the calcium phosphate dot material of the present invention.

### DETAILED DESCRIPTION OF THE INVENTION

In order to accomplish the aforementioned goal, (1) the present invention provides a calcium phosphate ion solution.

In the first embodiment, a method for preparation of calcium phosphate ion solution comprises the steps of:

1) preparing a solution of calcium ions and phosphate ions by dissolving calcium phosphate crystals or salts of calcium and of phosphate in an acidic solution;

2) mixing the acidic solution of calcium and phosphate ions of step 1 with an alkaline solution at a low temperature; and

3) excluding amorphous calcium phosphate particles or crystals which can act as nuclei for nucleation and growth of crystals, from the solution prepared in step 2, to obtain ion solution rich in unreacted free calcium and phosphate ions through preventing further nucleation and growth of crystals in the solution.

Mixing an acidic solution with an alkaline solution of step 2 is performed at 0-37° C., preferably 0-20° C. More preferably, the temperature is the lowest possible temperature in the said temperature range, so that it can inhibit the formation of calcium phosphate precipitate during mixing. Most preferably, the temperature is 0° C.

Also, the calcium phosphate ion solution prepared in the present invention is stored as a buffer solution, and is maintained at a low temperature of 0-10° C. At the lowest possible temperature in the above temperature range, a highly supersaturated calcium phosphate ion solution can be maintained without precipitation. Most preferably, the calcium phosphate ion solution is stored at 0° C.

In the second embodiment, the method for preparation of calcium phosphate ion solution comprises the steps of:

1) preparing the ion solution of pH 6.0-10.0 containing phosphate ion,
2) preparing the ion solution of pH 6.0-10.0 containing calcium ion, and
3) preparing the calcium and phosphate ion solution of pH 6.0-10.0 by mixing the ion solution of step 1 with the ion solution of step 2.

In the present invention, “calcium phosphate ion solution” is prepared whose concentrations of phosphate and calcium ions are 1-25 mM respectively, and ion concentration product of calcium and phosphate in the ion solution is in the range of 1-64 mM².

The mixing temperature in step 3 is maintained at 0-37° C., preferably 0-20° C. More preferably, the temperature is the lowest possible temperature in the said temperature range, so that it can inhibit a formation of calcium phosphate precipitate. Also, in order to prevent calcium phosphate precipitations which can be formed due to locally increased concentration at the time of mixing, the mixture solution is added slowly by distributing it in a small amount by using the stirring method or the mechanical method. Preferably, mechanical methods for preventing a local increase in the ion concentration product of the mixing solution can be exemplified by using a peristaltic pump for continuous additions in a small amount or by using a spray.

Low-speed addition of the mixture solution and high-speed stirring of the mixing solution promote the diffusion of the adding ions, so that the spontaneous formation of calcium phosphate precipitation caused by locally increased calcium and phosphate ion concentration product of the mixture can be inhibited or delayed. Therefore, the preparation method of the second embodiment is an economic manner which can mass-produce calcium phosphate ion solution without procedure of a separate filtering or a centrifugation for removing calcium phosphate precipitations.

Also, the present invention provides another method for preparing calcium phosphate ion solution, comprising the steps of:

1) preparing an ion solution below pH 6.0 containing phosphate ion and calcium ion, and
2) preparing the calcium phosphate ion solution of pH 6.0-10.0 by adding a alkaline solution to the ion solution of step 1.

The mixing temperature in step 2 and the other conditions are identical with the temperature and condition of said method.

In step 2, the mixing temperature is maintained at 0-37° C., preferably 0-20° C. More preferably, the temperature is the lowest possible temperature in the said temperature range, so that it can inhibit a formation of calcium phosphate precipitate. Also, in order to prevent formation of calcium phosphate precipitation in the mixing ion solution due to the locally increased ion concentration at the time of mixing, the mixture solution is added slowly by distributing it in a small amount by using the stirring method or the mechanical method. Preferably, mechanical methods for promoting a rapid diffusion of the mixture solution can be exemplified by using a peristaltic pump for continuous additions in a small amount or by using a spray.

Also, the calcium phosphate ion solution prepared in the second embodiment is stored as a buffer solution, and is maintained at a low temperature of 0-10° C. A highly supersaturated calcium phosphate ion solution can be maintained without precipitation by keeping it at the lowest possible temperature in the above temperature range. Most preferably, the calcium phosphate ion solution is stored at 0° C.

In the preparation method of the calcium phosphate ion solution of the present invention, 1) pH, 2) temperature, 3) mixing velocity, and 4) ion concentration affect the spontaneous formation of calcium phosphate precipitate in the ion solution. The lower the pH, the lower the temperature, the slower the mixing velocity, and the lower the ion concentration, the formation of calcium phosphate precipitate is surpassed or delayed.

It is preferable to use a buffer system in order to obtain a uniform calcium phosphate solution. Any buffer solutions of organic ion or inorganic ion can be employed in the present invention. The pH of the ion solution is controlled by adding acid or base, more particularly by inorganic acid, organic acid, inorganic base or organic base. At this time, examples of inorganic acid are selected from a group consisting HCl, HBr, H₂SO₄, H₃PO₄, HNO₃, H₂CO₃, HClO₄ and H₃BO₃. and examples of organic acid are selected from a group consisting of N-[2-hydroxyethyl]piperazine-N′-[2′-ethanesulfonic acid, N-tris-[hydroxymethyl]methyl-2-aminoethanesulfonic acid, 1,4-piperazinediethanesulfonic acid, (2-N-morpholino)propanesulfonic acid and acetic acid. Preferably, HCl and N-[2-hydroxyethyl]piperazine-N′-[2′-ethanesulfonic acid are used. Also, examples of inorganic base are selected from a group consisting of NaOH, KOH, LiOH, Ca(OH)₂, Mg(OH)₂ and NH₄OH and examples of organic base are selected from a group consisting of tris[hydroxymethyl]aminomethane, bis[2-hydroxyethyl]aminotris[hydroxymethyl]methane, 1,3-bis[tris(hydroxymethyl)methylamino] propane. The organic base is selected depending on the preferred pH, considering the buffering range of each buffer.

(2) The present invention provides calcium phosphate colloid ion solutions which are prepared from the calcium phosphate ion solution at a low temperature.

Calcium phosphate colloid ion solutions, whose colloidal particle sizes are in the range of 1 nm-1,000 nm, are prepared by maintaining the calcium phosphate ion solution at 0-60° C.

The calcium phosphate colloid ion solution contains well dispersed calcium phosphate colloidal particles which are initially formed in the calcium phosphate ion solution at low temperature. Colloidal particles have a capability of adhering to solid substrate. Calcium phosphate colloid ion solution can be prepared in various different types depending on temperature. More particularly, adherence and growth of colloidal particles to the solid substrate is higher at lower temperature, while, in a solution, the growth of colloidal particles is promoted at higher temperatures.

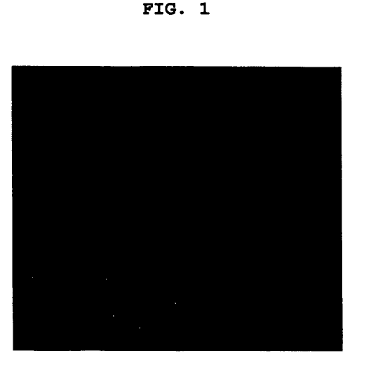

FIG. 1 is the picture of calcium phosphate colloidal particles adhered to a substrate as dots, which is observed on the formvar film put over the calcium phosphate ion solution free of colloids at low temperature, after, adding the calcium phosphate colloid ion solution to the ion solution free of colloids.

The calcium phosphate colloid ion solution of the present invention can maintain colloid status for a long period of time at a low temperature. Colloidal particles can adhere and grow on the solid substrate, and thus, they can be used to obtain calcium phosphate dots, islands, and thin films on the substrate. In addition, they can also grow as calcium phosphate granules in the ion solution. Therefore, the calcium phosphate colloidal particles act as precursors in the preparation of dots, islands, thin films, or granules of calcium phosphate in the present invention.

(3) The present invention provide calcium phosphate dots, islands, and thin films on the solid substrate prepared using calcium phosphate colloid ion solution. Also, the present invention provides calcium phosphate granules in the ion solution prepared using calcium phosphate ion solution.

The calcium phosphates of the present invention are prepared in various forms depending on whether the calcium phosphate colloid ion solution is applied to solid substrate or solution.
A. Calcium phosphate dots or islands prepared by applying the calcium phosphate colloid ion solution to a solid substrate

The present invention provides a material containing calcium phosphate dots or islands, which are prepared by pouring the calcium phosphate colloid ion solutions over the solid substrate at 1-60° C.

The calcium phosphate dots are formed on the solid substrate in various sizes of amorphous, crystalline form or mixture thereof. The calcium phosphate dots are discontinuously scattered on the solid substrate and provide dual surfaces wherein the empty space between each dot expose the solid substrate.

The dual surface can be used as a biomaterial, which can provide cells with calcium phosphate surface for high cell adhesion and activity as well as substrate surface between dots where cells deposit matrix to bind tissue to the biomaterial substrate directly. Based on the above properties, various cells such as epithelial cells, muscle cells, nerve cells, connective tissue cells and osteoblast cell etc. can be proliferated and differentiated on such dual surfaces.

The following is the three methods for controlling the size of the above calcium phosphate dots.

First, it can be controlled by temperature of the ion solution. In detail, as the temperature of the ion solution gets lower, the dots get smaller. Further, the smaller sized dots are converted into crystals at lower temperature. On the other hand, as the temperature of the ion solution gets higher, the dots get larger. Further, the larger sized dots are converted into crystal at higher temperature. Therefore, appropriate sized dots can be prepared by controlling the temperature of ion solution, preferably in the range of 1-40° C.

In the second method, the pH of the ion solution is controlled to a range of pH 6.0-9.0. The preferable range is selected from the range of pH 6.0-8.0. More particularly, as the pH gets lower, the size of the dots gets smaller and further the size of the dots at which they are converted into crystals get smaller. On the other hand, as the pH gets higher, the size of the dots gets bigger, and further the size of the dots at which they are converted into crystals get bigger.

In the third method, the reaction time can be controlled. The size of the dots gets bigger with the progress of time, and dots gradually get converted into crystals to form crystal islands.

In the present invention, the size of amorphous dots is 5-1,000 nm and the size of crystal islands is 5-5,000 nm.

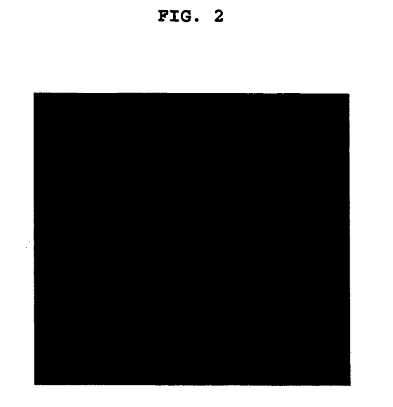

FIG. 2 is a transmission electron microscopic picture of amorphous phase dots formed through adhesion of calcium phosphate colloidal particles to a formvar film. Dots in the size of 20-90 nm in diameter were formed, which are scattered at high density, 20-28 dots in 1 μm². Further, it provides a dual surfaces of calcium phosphate surface and substrate surface which was exposed between amorphous phase dots.

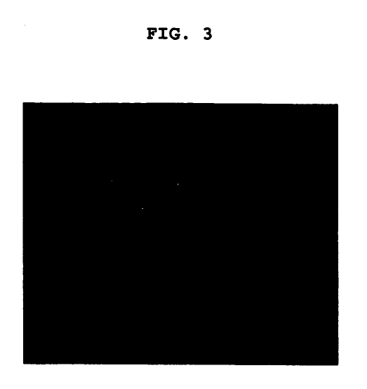

FIG. 3 is a transmission electron microscopic picture (×100,000) of the transitional stage when amorphous phase dots convert to crystals on the formvar film. From the above results, it was found that fibrous crystals spread out from the calcium phosphate dots.

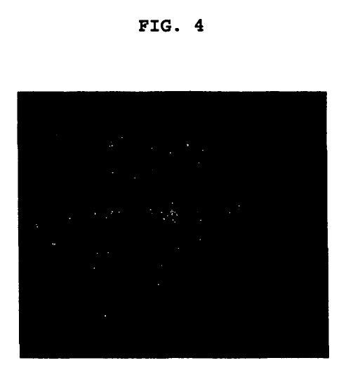

Further, as shown in FIG. 4, the calcium phosphate amorphous phase dots are converted into crystals on the formvar film and grow to form crystal islands. It also provides dual surfaces of crystal island surface and the formvar film surface which is the empty space between the crystal islands.
B. Calcium phosphate thin film prepared by applying calcium phosphate colloid ion solution to the solid substrate

Another form of the calcium phosphate materials which are obtained by applying calcium phosphate colloid ion solution to the solid substrate is a thin film of calcium phosphate formed on solid substrate.

The calcium phosphate thin film is formed through fusion and growth of calcium phosphate dots or crystals on solid substrate. The present invention provides thin film that can be prepared by pouring the calcium phosphate colloid ion solution over the solid substrate at 1˜60° C. and maintaining it for a certain period of time so that the dots or crystals can fully fuse and grow. More preferably, the temperature condition is in the range of 1-40° C.

Calcium phosphate thin film comprises amorphous phase thin film, crystalline thin film or mixture thin film thereof formed on solid substrates.

Amorphous phase dots can be converted into crystal islands by controlling the temperature and concentration of ion solution. If other conditions are the same, crystalline thin film can be easily prepared by increasing the concentration or the temperature of the ion solution through conversion of the amorphous calcium phosphate dots to crystals.

The calcium phosphate thin film can be used as a coating material for the biomaterial surface to provide it with a high biocompatibility, or as a heavy metal removing filter for clarifying water using its high adsorptive power against heavy metals [Chen, X.-B., Wright, J. V., Conca, J. L., Peurrung, L. M. Environ. Sci. Technol.1997; 31(3); 624-631., Lusvardi G, Malavasi G, Menabue L, Saladini M. Waste Manag. 2002;22(8):853-857]. In addition, it can be used as a deodorant removing odor or gas using its high adsorptive properties against organic molecules and inorganic molecules.

FIG. 4 is a transmission electron microscopic picture of the calcium phosphate crystal islands which is converting into a thin film of calcium phosphate on the formvar film.

Any hydrophilic surface and hydrophobic surface can be employed as substrates for calcium phosphate dots, islands, or thin film. Preferably, the solid substrate is selected from a group consisting of organic polymers, metals, ceramics, glasses and biological tissues of animals or plants.

Any natural or artificially prepared organic polymer can be employed. Organic polymer can be selected from a group consisting of polystyrene, polycarbonate, polyglycolic acid, polylactic acid and poly lactic glycolytic acid, for example.

Also, any solid metal can be employed, and most preferably, titanium, if used as a biomaterial.

There is no limitation in the geometric form of the substrates for the preparation of calcium phosphate dots, islands, or thin film. Various structures such as a plate, tubular, cube, cone, columns or a complex type of them, and solid surfaces that may be electrically charged or not, can be applied.
C. Calcium phosphate granules prepared in calcium phosphate colloid ion solution

The present invention provides calcium phosphate granules prepared in the ion solution by raising the temperature of calcium phosphate colloid solution to 40-100° C.

Colloidal particles preferably grow in the solution when the reaction temperature is raised over the temperature below which calcium phosphate dots, islands, or thin films are formed preferably. At this temperature, colloidal particles grow rather than being adhere to the surface. Since amorphous phase calcium phosphate colloidal particles maintain its amorphous phase initially and convert to crystalline granules later, the present invention provides both amorphous granules and crystal granules.

Temperature to obtain granules depends on the concentration or pH of the ion solution. Lower temperature is enough when the pH or ion concentration of the ion solution is higher. Phases of granules whether they are amorphous or crystalline depend on the temperature, concentration, and pH of the ion solution.

Also, calcium phosphate granules can be prepared by adding excessive calcium ion or phosphate ion to the calcium phosphate colloid ion solution, or by increasing the alkalinity.

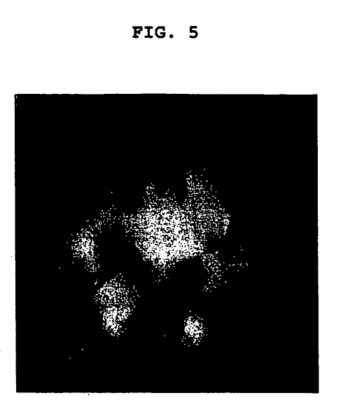

FIG. 5 is a scanning electron microscopic picture (×2,000) of granules of calcium phosphate crystals, whose size is 2.5-3.5 μm (n=50).

The calcium phosphate granule of the present invention is a spherical shape. Thus it has a wide surface area. A High surface area with other properties of calcium phosphate such as a high surface reactivity and a high adsorptivity against organic molecules and inorganic ions, make calcium phosphate granules apply to drug delivery or matter separation.

Practically and presently the preferred embodiments of the present invention are illustrative as shown in the following examples.

However, it will be appreciated that those skilled in the art, on consideration of this disclosure, may make modification and improvements within the spirit and scope of the present invention.

### 1. Preparation of Calcium Phosphate Ion Solutions

### EXAMPLE 1

### Preparation of Calcium Phosphate Ion Solution 1

Phosphate-buffered solution containing 4.0 mM of phosphate was prepared and its pH was adjusted to 7.5 by adding 1N NaOH. In 20 ml of the phosphate-buffered solution containing 4.0 mM of phosphate, 400 μl of 200 mM CaNO₃ solution was added at the rate of 300 μl/min at 2.5° C. At this time, a peristaltic pump was used to control the mixing velocity slowly. Phosphate-buffered solution containing phosphate ion was rapidly stirred so that no precipitation is formed when the solution comprising calcium ion is being added. No formation of spontaneous precipitate in the solution was determined by Particle Analyzer (Zetasizer 3000, Malvern, United Kingdom). The calcium phosphate ion solution prepared above was stored at 2.5° C. until used.

### EXAMPLE 2

### Preparation of Calcium Phosphate Ion Solution 2

Phosphate-buffered solution containing 4.5 mM of phosphate ion was prepared and its pH was adjusted to 5.0 by adding 1N HCl. In 20 ml of phosphate-buffered solution containing 4.0 mM of phosphate, 200 μl of 450 mM CaNO₃ solution was added to prepare calcium phosphate acidic ion solution. Then pH of the acidic ion solution was increased with 1N NaOH to 7.4 at 2.5° C. Peristaltic pump was used to slowly add NaOH at the rate of 300 μl/min. The acidic ion solution containing phosphate ion and calcium ion was rapidly stirred so that no precipitation was formed when NaOH is being added. No formation of precipitate in solution was determined by Particle Analyzer (Zetasizer 3000, Malvern, United Kingdom). The calcium phosphate ion solution prepared above was stored at 2.5° C. until used.

### EXAMPLE 3

### Preparation of Calcium Phosphate Ion Solution 3

A calcium phosphate ion solution was prepared by the same condition of Example 1 except that tris[hydroxymethyl]aminomethane)-HCl buffer solution of pH 7.4 was used in place of phosphate buffered solution.

### EXAMPLE 4

### Preparation of Calcium Phosphate Ion Solution 4

A calcium phosphate ion solution was prepared by the same condition of Example 2 except that N-[2-hydroxyethyl]piperazine-N′-[2′-ethanesulfonic acid]) was used in place of HCl as acidic solution and tris[hydroxymethyl]aminomethane was used in place of NaOH as alkaline solution.

### EXAMPLE 5

### Preparation of Calcium Phosphate Ion Solution 5

A solution of 17.7 mg of Ca(NO₃)₂.4H₂O dissolved in 250 ml of distilled water and a solution of 40 mg of (NH₄)₂.HPO₄ and 1 ml of liq. ammonia dissolved in 500 ml of distilled water were quickly mixed, filtered and freeze-dried to prepare apatite crystal. 400 mg of apatite crystal was dissolved in 40 ml of 0.2 M HCl to prepare an acidic ion solution containing ions of calcium and phosphate. The acidic ion solution was diluted with 0.2 M HCl in a ratio of 30% (v/v) and then this diluted acidic ion solution was diluted again with PBS in a ratio of 1:1.7(w/w). Then the diluted ion solution with PBS was mixed with 0.2 N NaOH solution diluted with PBS in a ratio of 1:1.7(w/w). At this time, pH of the mixed solution was adjusted to 7.6. Next, a neutralized ionic buffer solution free of precipitate was obtained by excluding amorphous calcium phosphate precipitate formed during a procedure of mixing the acidic ion solution with NaOH solution through filtering the solution with 0.2 micrometer size filter. The temperature of all the above solutions were maintained at 4° C. The calcium phosphate ion solution prepared above was stored at 4° C. until used.

### EXAMPLE 6

### Preparation of Calcium Phosphate Ion Solution 6

Phosphate-buffered solution containing 4.0 mM of phosphate ion was prepared and its pH was adjusted to 7.5 with 1N NaOH. In 20 ml of phosphate-buffered solution, 20 ml of 4 mM CaNO₃ solution was added at the rate of 500 μl/min at 2.5° C. Peristaltic pump was used for the purpose of slow mixing. The phosphate-buffered solution containing phosphate ion was rapidly stirred so that no precipitation was formed when the solution comprising calcium ion was being added. No formation of precipitate in ion solution was determined by Particle Analyzer (Zetasizer 3000, Malvern, Germany). The calcium phosphate ion solution prepared above was stored at 2.5° C. until used.

### 2. Preparation of Calcium Phosphate Colloid Ion Solutions

### EXAMPLE 7

### Preparation of Calcium Phosphate Colloid Ion Solution

The ion solution prepared in example 1 was heated at various temperatures and reaction times to prepare calcium phosphate colloid ion solution.

The size of calcium phosphate colloidal particle prepared was determined by the Particle Analyzer(Zetasizer 3000, Malvern, United Kingdom) and showed in table 1.

TABLE 1

Size of calcium phosphate colloidal particles depending on reaction temperature and time.

(nm)([CaxP]=16 mM², 18° C.)

| Time (minute) | 5° C. | 18° C. |
|---|---|---|
| 0 | 0 | 0 |
| 15 | 0 | 212 |
| 30 | 0 | 734 |
| 60 | 0 | 963 |
| 120 | 0 | 1,286 |

As shown in table 1, as the temperature of the calcium phosphate colloid ion solution gets higher and as more time passes, the particle size gets bigger.

As a separate experiment, the ion solution prepared by the same method as in example 1 except that they were prepared under different pH conditions, was heated for different times at 18° C. to prepare calcium phosphate colloid ion solution.

The size of calcium phosphate colloid particle prepared was determined using Particle Analyzer (Zetasizer 3000, Malvern, United Kingdom).

TABLE 2

Size of calcium phosphate colloidal particles according to various reaction pHs and times

(nm)([CaxP]=16 mM², 18° C.)

| Time (minute) | pH 6.8 | pH 7.0 | pH 7.5 |
|---|---|---|---|
| 0 | 0 | 0 | 0 |
| 15 | 0 | 0 | 212 |
| 30 | 0 | 10.5 | 734 |
| 60 | 0 | 9.0 | 963 |
| 120 | 0 | 14.2 | 1,286 |

From the above results, it is shown that the formation and growth of the calcium phosphate colloidal particles in the ion solution is delayed in low pH conditions, and accelerated at high pH conditions.

### EXAMPLE 8

### Preparation of Calcium Phosphate Colloid Ion Solution and Determination of its Capability of Adhesion to Solid Substrate

The concentration of the solution comprising phosphate and calcium ions was set at 8.2 mM and 4.0 mM, respectively and the calcium phosphate ion solution was prepared in the same manner as in example 1. The prepared calcium phosphate ion solution was heated at 18° C. for 30 minutes, and then cooled to 4° C. Then, it is mixed with the same amount of another ion solution free of colloidal particles maintained at 4° C. Then, the formvar film formed on the nickel grid for transmission electron microscopy was floated over the surface of the mixed ion solution and maintained it at 4° C. for 30 minutes. Then, the formvar film was washed with distilled water, and it was found out that calcium phosphate colloid added adhered to the formvar film, which indicates that calcium phosphate has a ability to adhere to the surface (FIG. 1).

### 3. Calcium Phosphate Colloid Ion Solutions Applied on Solid Substrate.

### EXAMPLE 9

### Preparation of Calcium Phosphate Dot 1

The calcium phosphate ion solution prepared in example 5 was poured into culture dish for cell culture (Corning, USA), its temperature was raised to 37° C., and was maintained at the same temperature for 10 minutes to prepare dots of calcium phosphate.

### EXAMPLE 10

### Preparation of Calcium Phosphate Dot 2

(step 1): Preparation of Dot of Amorphous Calcium Phosphate

Nickel grids covered with formvar film for transmission electron microscopy were floated on the calcium phosphate ion solution prepared in example 6 for 120 minutes at 18° C. to obtain dots of amorphous calcium phosphate.

Grids were collected at 15, 30, 60 and 120 minutes, respectively and formvar films were observed by transmission electron microscopy. FIG. 2 shows a transmission electron microscopic picture of dots of amorphous calcium phosphate which were examined on the grid collected at 120 minutes.

(step 2): Conversion of Amorphous Calcium Phosphate Dots to Crystals

Dots of amorphous calcium phosphate on formvar film covering over nickel grid for transmission electron microscopy prepared in step 1 was floated on the surface of ion solution again, and maintained for 3 hours at 18° C. Then it was found that calcium phosphate dots were converted to crystals. FIG. 3 shows a transmission electron microscopic picture of conversion of the dots of amorphous calcium phosphate to crystals.

(step 3): Preparation of Calcium Phosphate Crystal Islands

Dots of amorphous calcium phosphate on nickel grid for transmission electron microscopy prepared in step 1 was floated on the surface of the ion solution and maintained for 6 hours at 18° C. The calcium phosphate dots were converted to crystals and grown to crystal islands. FIG. 4 is a transmission electron microscopic picture of crystal islands of calcium phosphate crystals.

### EXAMPLE 11

### Preparation of Thin Film of Calcium Phosphate 1

The ion solution prepared in example 5 was poured into a culture dish(Corning, USA), and incubated at 8° C. for 2 days to form thin film of calcium phosphate.

### EXAMPLE 12

### Preparation of Calcium Phosphate Thin Film 2

Formvar film covering over nickel grid for transmission electron microscopy was floated on the surface of the ion solution prepared in example 6 and maintained for 12 hours at 18° C. to prepare calcium phosphate thin film.

FIG. 5 is an picture showing thin film of calcium phosphate using transmission electron microscopy.

### 4. Calcium Phosphate Colloid Ion Solution Applied in Solution Phase

### EXAMPLE 13

### Preparation of Calcium Phosphate Granules 1

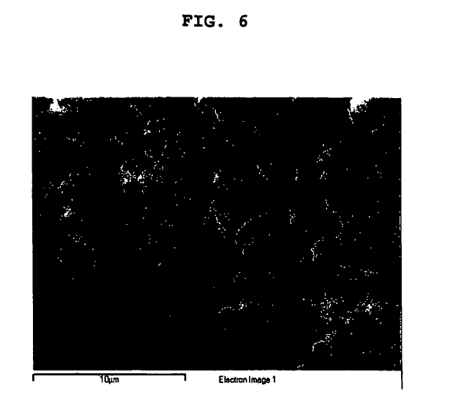

The calcium phosphate ion solution prepared in example 5 was poured into polycarbonate vessel, and then increased the temperature to 60° C. at the rate of 5 ° C./min to prepare the solution containing calcium phosphate granules. After this, the calcium phosphate granules were collected by centrifugation of the ion solution, and then washed with distilled water. The granules were dried on formvar film formed over nickel grid for transmission electron microscopy and observed by scanning electron microscopy (FIG. 6). The calcium phosphate granules were an amorphous phase in the first heating and converted to granules of calcium phosphate crystals with the passage of time.

### EXAMPLE 14

### Preparation of Calcium Phosphate Granules 2

Calcium phosphate granules were prepared by the same method of example 13 except using calcium phosphate colloid ion solution prepared in example 6.

### EXAMPLE 15

### Preparation of Calcium Phosphate Granules 3

In 1 ml of calcium phosphate ion solution prepared in example 1, 100 μl of 400 mM calcium ion was added to obtain solution containing calcium phosphate granules. Calcium phosphate granules were collected by centrifugation of the solution and washed with distilled water. The calcium phosphate granules were mounted on formvar film covering nickel grid for transmission electron microscopy and observed by scanning electron microscopy after drying. The calcium phosphate granules of an amorphous phase was observed. Therefore, the granules of amorphous phase was directly obtained from calcium phosphate ion solution without heating.

### EXAMPLE 16

### Preparation of Calcium Phosphate Granules 4

Ion solution containing calcium phosphate granules was obtained by adding NaOH to calcium phosphate ion solution prepared in example 1 to set pH 10. After this, the calcium phosphate granules were collected by centrifugation of the solution and washed with distilled water. The calcium phosphate granules were mounted on formvar film covering nickel grid for transmission electron microscopy, and observed by scanning electron microscopy after drying. The calcium phosphate granule of amorphous phase was observed. Therefore, the granule of amorphous phase can be directly obtained from calcium phosphate ion solution without heating.

### EXPERIMENTAL EXAMPLE 1

### Cell Adhesion Test Over Calcium Phosphate Dots

To determine biocompatibility of calcium phosphate dots prepared in example 9, the cell adhesion test was accomplished.

MG63 osteoblast(ATCC) was placed in culture dish where crystalline dots of calcium phosphate apatite were pre-formed. Cells were cultured in CO₂ incubator supplied with 95% air and 5% CO₂ at 37° C. After 6 days, the surface of culture dish was examined by phase contrast microscopy(×200).

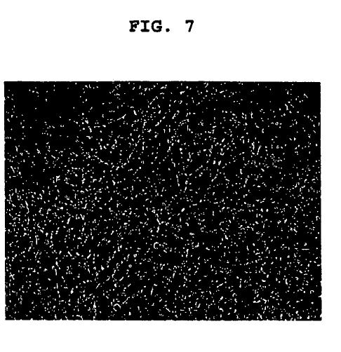

As shown in FIG. 7, cells attached well and proliferated into several layers over the calcium phosphate dots pre-formed at high density by the same method as in example 9. As the result, it was confirmed that the crystal dots of calcium phosphate in the present invention has biocompatibility and can be used as biomaterial.

### EXPERIMENTAL EXAMPLE 2

### Metal Ion Removing Test of Calcium Phosphate Thin Film

The calcium phosphate thin film was prepared over 4 well cell culture dish by the same method of example 12. Then 1 ml of ion solution containing 3.11 μg/ml of zinc or 0.81 μg/ml aluminum was poured to the wells, and maintained for 24 hours. After this, the concentration of zinc ion or aluminum ion left in the ion solution was determined.

After 24 hours, 0.035 μg/ml of the zinc ion was detected and no aluminum ion was detected at all in the ion solution over the thin film of calcium phosphate.

As the result, it was confirmed that the calcium phosphate thin film of the present invention have a highly ability to remove heavy metals from the heavy metal ion solution.

### EXPERIMENTAL EXAMPLE 3

### Inorganic Ion Absorption Test of Calcium Phosphate Granules

To determine the surface reactivity of calcium phosphate granules prepared in example 13, the following test with fluorine ion was performed.

In 0.5 ml of solution containing calcium phosphate crystal granules prepared in example 13, 41.99 ppm of NaF was added. The mixture was reacted for 1 hours at 37° C. After this, the crystal granules were collected by centrifugation for 1 minute at 1,000×g and washed with distilled water three times. Amount of fluorine bound to crystal granules was determined by fluorine measurement electrorod(Corning, USA) after dissolving crystal granules in 0.1 N HCl.

As the result, fluorine(F⁻) adhered to crystal granules of calcium phosphate was 38.83 ppm, which showed a high absorption rate of 92%.

### EXPERIMENTAL EXAMPLE 4

### Organic Molecule Absorption Test of Calcium Phosphate Granules

To determine the surface reactivity of calcium phosphate granules prepared in example 13 to organic molecules, albumin was used and the following test was performed.

100 μg/ml of albumin was added in 1 ml of the solution containing calcium phosphate granules prepared in example 13. And the mixture was stirred for 1 hour at 37° C. After this, the crystal granules were collected by centrifugation for 1 minute at 1,000×g, washed with distilled water three times. The amount of albumin adsorbed to the crystal granules was determined by colorimetric method using protein assay kit(Bio-Rad, USA).

As the result, the amount of albumin adsorbed to crystal granules of calcium phosphate was 1.1 μg. Therefore, it is confirmed that the surface of calcium phosphate crystal granules has the reactivity against organic molecule.

### INDUSTRIAL APPLICABILITY

As stated above, the present invention provides methods of mass-producing calcium phosphate ion solutions without procedure of filtering or centrifugation to remove calcium phosphate precipitate which is used to be formed in supersaturated calcium phosphate ion solution. This was accomplished by inhibiting or delaying the spontaneous precipitation of calcium phosphate compounds through preparing the ion solution at low temperature as well as rapidly diffusing adding ions not to accumulate locally to induce precipitation.

Second, the present invention provides calcium phosphate colloid ion solutions prepared from the calcium and phosphate ion solution. The present invention also provide dots, islands, thin films of amorphous or crystalline phases prepared from calcium and phosphate colloid ion solution, which can be used as biomaterials.

Third, the present invention provides biomaterial surfaces dually exposed to cells as the one surface of discontinuously scattered calcium phosphate dots or islands and the other surface of the substrate itself revealed between calcium phosphate dots or islands, which promotes cell adhesion.

Fourth, the present invention provides calcium phosphate thin film prepared from calcium phosphate colloid ion solution, which can be used as biomaterials, filters to remove heavy metals, or deodorizer.

Fifth, the present invention provides amorphous or crystalline calcium phosphate granules prepared in ion solution by growing colloidal particles to larger granules and converting amorphous calcium phosphate granules to crystalline phase calcium phosphate granules.

Sixth, the calcium phosphate granules prepared in calcium phosphate colloid ion solution can be applied to carriers for drug or cell delivery and filters for mass separation.

1. A method for preparing calcium phosphate ion solutions, comprising the steps of:
1) preparing the ion solution of pH 6.0-10.0 containing phosphate ion;
2) preparing the ion solution of pH 6.0-10.0 containing calcium ion; and
3) mixing the (1) ion solution with (2) ion solution to prepare calcium phosphate solution of pH 6.0-10.0,
wherein the concentration of ion solution containing phosphate ion is 1-25 mM, the concentration of ion solution containing calcium ion is 1-25 mM, and the ion concentration product is 1-64 mM

2. (canceled)

3. The method according to claim 1, wherein step 3 is accomplished at 0-37° C.

4. The method according to claim 1, wherein step 3 is accomplished by using the method selected from the methods wherein the mixture solution is added slowly by distributing it in a small amount by using the stirring method or the mechanical method.

5. A method for preparing calcium phosphate ion solutions, comprising the steps of:
1) preparing an ion solution below pH 6.0 containing phosphate ion and calcium ion; and
2) preparing the calcium phosphate ion solution of pH 6.0-10.0 by adding an alkaline solution to the ion solution of step 1,
wherein the concentration of ion solution containing phosphate ion is 1-25 mM, the concentration of ion solution containing calcium ion is 1-25 mM, and the ion concentration product of calcium phosphate ion solution is 1-64 mM².

6. (canceled)

7. The method according to claim 5, wherein step 2 is accomplished at 0-37° C.

8. The method according to claim 5, wherein step 3 is accomplished by using the method selected from the methods wherein the mixture solution is added slowly by distributing it in a small amount by using the stirring method or the mechanical method.

9. The method according to claim 1, wherein the pH is controlled by inorganic acid, organic acid or their mixture.

10. The method according to claim 9, wherein the inorganic acid is selected from the group consisting of HCl, HBr, H₂SO₄, H₃PO₄, HNO₃, H₂CO₃, HClO₄ and H₃BO₃, and the organic acid is selected from the group consisting of N-[2-hydroxyethyl]methyl-2aminoethanesulfonic acid, 1,4-piperazinediethanesulfonic acid, (3-N-morphlino) propanesulfonic acid and acetic acid.

11. The method according to claim 1, wherein the pH is controlled by inorganic base, organic base or their mixture.

12. The method according to claim 11, wherein the inorganic base is selected from the group consisting of NaOH, KOH, LiOH, Ca(OH)₂, Mg(OH)₂ and NH₄OH, the organic base is selected from the group consisting of tris [hydroxymethyl] aminomethane, bis [2-hydroxyethane] aminotris [hydroxymethyl] methane and 1,3-bis [tris(hydroxymethyl)methylamino] propane.

13. A calcium phosphate colloid ion solution containing 1 nm-1,000 nm sized colloidal particles prepared in calcium phosphate ion solution by maintaining the calcium phosphate ion solution prepared by the method of claim 1 at 0-60° C.

14. A material containing dots or islands prepared by pouring calcium phosphate colloid ion solution of claim 13 on solid substrate at 1-60° C.

15. A material containing dots or islands formed by method comprising the steps of:
1) a) dissolving calcium salt and phosphate salt in acidic solution to prepare solutions of calcium ion and phosphate ion; b) mixing the acidic solutions of calcium ion and phosphate ion prepared in step a) with alkaline solution at a low temperature; and c) removing granules or crystals of amorphous ion calcium phosphate in the solution prepared in said step to prepare calcium phosphate ion solutions;
2) maintaining the calcium phosphate ion solutions prepared in step 1) at 0-60° C. to form calcium phosphate colloidal particles in calcium phosphate ion solution; and
3) pouring the calcium phosphate colloid ion solution prepared in step 2) on solid substrate.

16. The material according to claim 14, wherein the size of dots or islands is 5 nm-15,000 nm.

17. The material according to claim 14, wherein the dots or islands are amorphous, crystal or mixture thereof.

18. A material containing thin film prepared by pouring the calcium phosphate colloid ion solution of claim 13 on solid substrate at 1-60° C. and maintaining the ion solution so that the dots or islands are sufficiently grown and fused.

19. A material containing thin film formed by a method comprising the steps of:
1) a) dissolving calcium salt and phosphate salt in acidic solution to prepare solutions of calcium ion and phosphate ion; b) mixing the acidic solutions of calcium ion and phosphate ion prepared in step a) with alkaline solution at 0˜37° C.; and c) removing granules or crystals of amorphous ion calcium phosphate in the solution prepared in said step to prepare calcium phosphate ion solutions;
2) maintaining the calcium phosphate ion solutions prepared in step 1) at 0-60° C. to prepare form calcium phosphate colloidal ion solution particles in calcium phosphate ion solution; and
3) pouring the calcium phosphate colloid ion solution prepared in step 2) on solid substrate.

20. The material according to claim 18, wherein the thin film is amorphous, crystal or mixture thereof.

21. The material according to claim 14, wherein the solid substrate is selected from the group consisting of organic polymers, metals, ceramics, glasses and biological tissues of animals or plants.

22. A filter for removing heavy metal, containing materials of claim 18.

23. A deodorizer containing materials of claim 18.

24. A calcium phosphate granules prepared by increasing the temperature of calcium phosphate colloid solution of claim 13 to 40-100° C.

25. A granule prepared in solutions by a method comprising the steps of:
1) a) dissolving calcium salt and phosphate salt in acidic solution to prepare solutions of calcium ion and phosphate ion; b) mixing the acidic solutions of calcium ion and phosphate ion prepared in step a) with alkaline solution at 0˜37° C.; and c) removing granules or crystals of amorphous ion calcium phosphate in the solution prepared in said step to prepare calcium phosphate ion solutions;
2) maintaining the calcium phosphate ion solutions prepared in step 1) at 0-60° C. to prepare form calcium phosphate colloidal particles ion solution in calcium phosphate ion solution; and
3) increasing the temperature of the calcium phosphate colloid ion solution prepared in step 2) to 40-100° C.

26. The granules prepared according to claim 24, wherein the diameter of calcium phosphate granule is 5 nm-5,000 nm.

27. The granules according to claim 24, wherein the granules are prepared by adding excess calcium ion or excess phosphate ion to calcium phosphate colloid ion solution, or by increasing alkalinity of the colloid ion solution.

28. The method according to claim 5, wherein the pH is controlled by inorganic acid, organic acid or their mixture.

29. The method according to claim 5, wherein the pH is controlled by inorganic base, organic base or their mixture.

30. A calcium phosphate colloid ion solution containing 1 nm-1,000 nm sized colloidal particles prepared in calcium phosphate ion solution by maintaining the calcium phosphate ion solution prepared by the method of claim 5 at 0-60° C.

31. The material according to claim 15, wherein the size of dots or islands is 5 nm-15,000 nm.

32. The material according to claim 15, wherein the dots or islands are amorphous, crystal or mixture thereof.

33. The material according to claim 19, wherein the thin film is amorphous, crystal or mixture thereof.

34. The material according to claim 15, wherein the solid substrate is selected from the group consisting of organic polymers, metals, ceramics, glasses and biological tissues of animals or plants.

35. The material according to claim 18, wherein the solid substrate is selected from the group consisting of organic polymers, metals, ceramics, glasses and biological tissues of animals or plants.

36. The material according to claim 19, wherein the solid substrate is selected from a group consisting of organic polymers, metals, ceramics, glasses and biological tissues of animals or plants.

37. A filter for removing heavy metal, containing materials of claim 19.

38. A deodorizer containing materials of claim 19.

39. The granules prepared according to claim 25, wherein the diameter of calcium phosphate granule is 5 nm-5,000 nm.

40. The granules according to claim 25, wherein the granules are prepared by adding excess calcium ion or excess phosphate ion to calcium phosphate colloid ion solution, or by increasing alkalinity of the colloid ion solution.
